(19) United States
(12) Patent Application Publication
(10) Pub. No.: US 2006/0212416 A1
(43) Pub. Date: Sep. 21, 2006

(54) Method for processing data to optimize and categorize matches

(75) Inventors: Maria C. Taylor, Lawrenceville, GA (US); Jeffrey W. Crowdus, Atlanta, GA (US)

Correspondence Address: MICHAEL P. MAZZA, LLC, 686 CRESCENT BLVD., GLEN ELYN, IL, 60137, US

(73) Assignee: DirectoryNET, LLC

(21) Appl. No.: 11/080,804

(22) Filed: Mar. 15, 2005

(51) Int. Cl. G06F 17/30

(52) U.S. Cl. 707/1

(57) ABSTRACT

A method for updating information, such as contact or transactional information, by optimizing the match of known data to data within aggregated databases. The known data may include data concerning one or more categories corresponding to an individual or entity, or to a particular transaction, for example. It is determined whether the known data constitutes an optimized match to a first order data set generated using a first order of predetermined ranking criteria. If a match does not exist, it is next determined whether the aggregated data constitutes an optimized match to a second order data set generated using a second order of predetermined ranking criteria. If a match still does not exist, checking for an optimized match continues using sequential order data sets (i.e., third order, fourth order, etc.) generated using corresponding sequential orders of predetermined ranking criteria, until an optimized match is found to exist. This search methodology has been found to yield higher matching rates and increased precision of the matched data than known searching methodologies.

### BACKGROUND OF THE INVENTION

The present invention relates to the field of data searching. More particularly, the invention is directed to the performance of data searching and mining operations to provide matching information, such as for use by directory assistance systems, credit or collection tracking systems, or for other uses as described below.

Businesses desiring updated contact information for their current or potential customers hire companies who perform data searching and mining operations and provide updates to their customer databases. Data resellers compare customer-provided records against aggregated databases and provide the customer with the closest match. Most data search companies promote match rates of about 35% to 65%, often with no indication of the actual precision of the match. Many data providers simply provide a list of potential matches and leave the determination of the best listing to the customer. In fact, many claimed “matches” prove to be inaccurate or out-of-date, resulting in lost time and effort as businesses attempt to contact customers with incorrect contact data.

An additional problem with data searching techniques is that known data matching logic does not satisfactorily account for different data input or spelling discrepancies (e.g. Peachtree vs. Peach Tree; Philips vs. Phillips; Mathews vs. Matthews). These data inconsistencies can prevent legitimate matches from being returned to the customer due to non-standard data entry practices.

Accordingly, businesses would benefit from new data searching techniques that result in an increase in data match rates. Advantages would also flow from using new data searching techniques that account for data input inconsistencies; providing a more reliable indicator of the precision of the data returned; and/or returning a single best match record.

### SUMMARY OF THE INVENTION

The present invention overcomes disadvantages of prior data search and match systems, techniques and methods, while providing new advantages not previously obtainable with such systems, techniques and methods.

In one preferred embodiment of the present invention, a method is provided for updating contact information by optimizing the match of known customer data to data within aggregated contact databases (such as aged information relating to the individuals or entities and/or current information relating to the entities). In this method, known customer data is received; this known customer data includes identity data including one or more identity categories corresponding to an entity (such as, e.g., last name; first initial; house number; street; city; state; and zip code or portion thereof) Next, it is determined whether the identity data is a data set constituting an optimized match to a first order data set generated using a first order of predetermined ranking criteria. This step is repeated with sequential order data sets (second order, third order, etc.) using corresponding sequential orders of predetermined ranking criteria until an optimized match is found to exist. (For example, the first order of predetermined ranking criteria may be narrower and/or more specific than the second order of predetermined ranking criteria, the second order may be narrower and/or more specific than the third order, etc.). Preferably, the predetermined ranking criteria includes a set of parameters used to determine a rank code (e.g., A, B, C, etc.), and the rank code, based on the highest order of the data set generated using the highest order of predetermined ranking criteria that provided the optimized match, is assigned to the optimized match. Third parties may be provided with a desired portion(s) of the data set of the optimized match, such as a telephone number or a street address, or information indicating whether or not a telephone number is the most current number associated with the known customer data corresponding to an entity. In another alternative embodiment, selected data comprising a subset of the data sets of the optimized matches may be reassigned prior to the step of providing to a third party only a desired portion of the data set of the optimized match; the data selected in the reassigning step may be selected based on whether the selected data or a portion thereof is available as having been published.

In one non-limited preferred example of the invention, the first order of ranking criteria may include at least four or more of the following: last name, first initial, first name, house or building number, street, city, state, and zip code or portion thereof. As another non-limiting example, the second order of ranking criteria may include three or more of the criteria comprising the first order of ranking criteria, but one less criterion in total number than the first order of ranking criteria. In one preferred embodiment, six orders of ranking criteria (e.g., A-F rank codes) are employed. In addition, at least one of the orders of ranking criteria (e.g., the A-rank) may include differing sets of match criteria within the same order (e.g., A1-rank, and A2-rank), and multiple match determinations may be attempted within the at least one order of ranking criteria.

Preferably, the optimized match includes a data set deemed to constitute the single best match for the corresponding known customer data. In addition to the optimized match, other data sets may be identified and/or stored which have significant correspondence with the known customer data. The match determination process may be initialized using the order of ranking criteria that corresponds to the number of identity categories that are present within the known customer data. In one embodiment, the optimized match may include two or more data sets deemed to constitute the best matches for the corresponding known customer data.

In one preferred embodiment of the invention, a determination that an optimized match exists may be made when all criteria within a particular order of ranking criteria are matched except the last name, and the initial of the last name constitutes a match. In an alternative embodiment, a determination that an optimized match exists may be made when all criteria within a particular order of ranking criteria are matched except the street name, and the initial of the street name constitutes a match.

In an alternative embodiment of the present invention, a method is provided for updating demographic information by optimizing the match of known customer data to data within aggregated demographic databases. In this method, known customer data is received, the known customer data including demographic data in one or more demographic categories corresponding to an entity. It is determined whether the demographic data is a data set constituting an optimized match to a first order data set generated using a first order of predetermined ranking criteria. If an optimized match is deemed not to exist, it may then be determined whether the demographic data is an optimized match to a second or sequential order data set generated using a second or sequential order of predetermined ranking criteria, using corresponding sequential orders of predetermined ranking criteria, until an optimized match is found to exist. Each of the alternative embodiments described above in this Summary of the Invention may also be employed for this method for updating demographic information.

In yet still another embodiment of the present invention, a method is provided for updating transactional information by optimizing the match of known customer data to transactional data within aggregated databases. In this method, known customer data is received, the known customer data including transactional data in one or more transactional categories corresponding to an entity. It is determined whether the transactional data is a data set constituting an optimized match to a first order data set generated using a first order of predetermined ranking criteria. If an optimized match is not deemed to exist, it is then determined whether the transactional data is an optimized match to a second or sequential order data set generated using a second or sequential order of predetermined ranking criteria, until an optimized match is found to exist. Again, each of the alternative embodiments described above may also be employed for this method for updating transactional information.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a schematic view illustrating a standard, prior art process for updating and ranking customer records;

FIG. 2 is a schematic view of one preferred embodiment of the present invention, showing an improved process for updating and ranking customer records; and

FIG. 3 is a schematic view of a second preferred embodiment of the present invention illustrating improved searching methodology for updating and ranking customer records using expanded criteria sets.

### DEFINITION OF CLAIM TERMS

The terms used in the claims of the patent as filed are intended to have their broadest meaning consistent with the requirements of law.

“Contact information” means identifying information for locating and contacting individuals or entities which may be updated using methods according to the present invention.

“Data set” means identity data for an entity (i.e., an individual or an organization).

“Demographic data” means information relating to various characteristics of an entity which may be of interest to a potential vendor, such as marital status, family size, locale, earning history, etc. (i.e., “demographic categories”).

“Entity” means an individual or an organization.

“Identity data” means information linked to an individual or entity in one or more identity categories (e.g., last name, first initial, social security number, street, locality, etc.).

“Omit address listing” means a record in an aggregated database in which the street address information has been suppressed. For example, a telephone subscriber may choose to have his or her street address omitted in the published telephone directory, but still have his or her phone number published.

“Optimized match” means a data set from the aggregated database(s) which constitutes a match yielded as a result of correspondence found with known customer data, using a process according to the claims of the present invention.

“Rank code” means an indicator assigned to each returned record from the aggregated database(s) signifying its precision compared to the provided data set.

“Ranking criteria” means a set of parameters used to determine the rank code.

“Sequential order data sets” means data sets generated using sequential orders of predetermined ranking criteria corresponding to sequential rank codes (e.g., first order data set, second order data set, third order data set, etc., corresponding to rank codes A, B, C, etc.).

“Transactional data” means data relating to a transaction concerning an entity, such as but not limited to on-line activity that may take place as a result of Internet browser click-throughs from a webpage, on-line purchases, etc.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Before describing the invention, a conventional searching method for updating contact information is first described, to highlight the differences between the known method and the present invention. For example, a customer update request may consist of substantially less or substantially more than a million data sets. In the known searching methods, certain relatively broad, primary criteria from each data set (typically last name, first initial, and locality) are compared against stored records within an aggregated database or selected portion thereof (which may consist of substantially less or substantially more than a 100 million records, for example) and a predetermined number of matched records (e.g., up to ten records per data set) are pooled. The predetermined number is desirable to limit the data returns to a manageable level. The pooled data may be compared against ranking criteria and assigned a rank code as a general indicator of the quality of the match. Finally, if requested, the customer's original data set may be appended with the latest contact information.

The more accurate the match is, the higher its rank code; for example, an “A” rank code might indicate that all (e.g.) seven criteria were matched, followed by a “B” rank code with six of seven matches, a “C” rank code with four, etc., with an “F” rank code indicating the fewest criteria/criterion matches. Other indicators may be assigned, such as a “G” rank code for unpublished numbers, or a code for do-not-call-list registrants. The known methods return the preset number of matches (e.g., up to ten matches) per customer input record, potentially returning multiple equally-ranked matches, or even missing the best matches due to the record limiter.

In summary, known searching methods collect a predetermined maximum number of matched records in a broad search by matching to a broad set of primary criteria (typically last name, first initial and locality). These primary matched results are then compared to all other criteria in the data set, and each record is ranked based on the number of criteria matched. All matched records are returned to the customer, who then decides which of the matches are most reliable, based on the rank code of the matches provided.

Table 1, below, illustrates an example of the criteria sets for known method rank codes, and corresponding match rates.

TABLE 1
Example of criteria set used for prior
known searching method rank codes

| Code | Minimum Ranking Criteria | Match Rate* |
|---|---|---|
| A | Last Name, First Initial, House #, Street, Locality | 15.3 |
| B | Last Name, House #, Street, Locality | 18.4 |
| C | Last Name, First Initial, Street, Locality | 0.7 |
| D | Last Name, Street, Locality | 2.4 |
| E | Last Name, First Initial, Locality | 11.1 |
| F | Last Name, Locality | 5.1 |
| G | Any listings above with a non-published number | 17.2 |

*average percentage of matches based on review of in excess of 22 million records

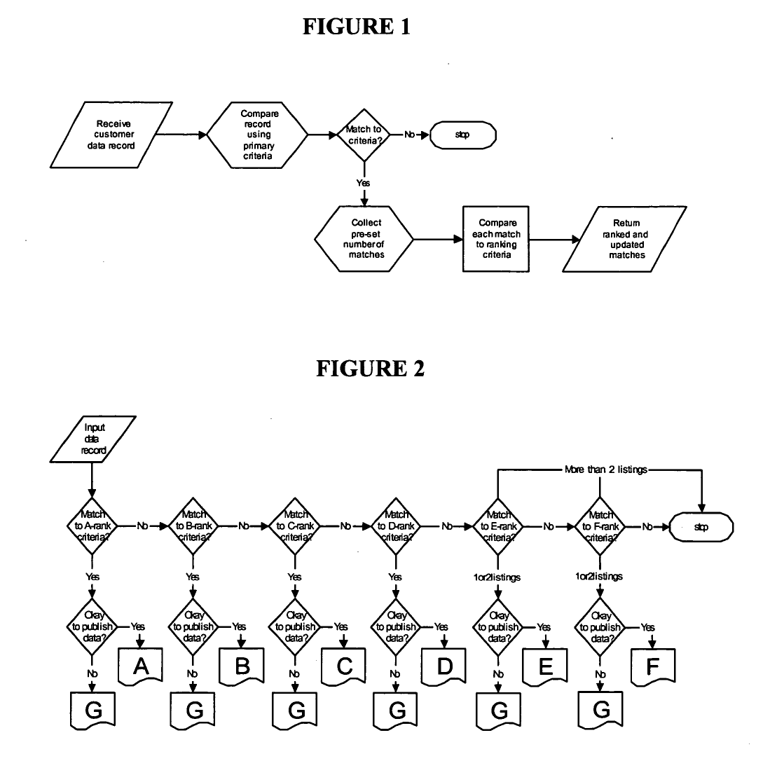

In this example, an A rank code indicates greater probability that the record is accurate, followed by a B rank code, C rank code, etc., with an F rank code being the fewest criteria matches. FIG. 1 provides a simple overview of the methodology employed by known searching methods for updating contact information.

Table 2, below, illustrates an example of a directory assistance search for Sarah Taylor on Peachtree Dr in Atlanta, Ga. Because it pools the first 10 records that match on Last Name, First Initial, City, and State, the known method returns the results shown.

The first record represents the input record.

TABLE 2
Sample match results from search using prior known searching method

| RANK | | LAST | FIRST | | | | | |
|---|---|---|---|---|---|---|---|---|
| CODE | TYPE | NAME | NAME | STREET | LOCALITY | STATE | ZIP | PHONE |
| | Query | TAYLOR | SARAH | PEACHTREE DR | ATLANTA | GA | | |
| E | Listing | Taylor | Dwayne A Sr | | Atlanta | GA | | 6783429561* |
| G | Listing | Taylor | S | | Atlanta | GA | | NP |
| E | Listing | Taylor | S | | Atlanta | GA | | 4042811651 |
| G | Listing | Taylor | S | | Atlanta | GA | | NP |
| E | Listing | Taylor | S | | Atlanta | GA | | 4047479193 |
| E | Listing | Taylor | S | | Atlanta | GA | | 4048452285 |
| E | Listing | Taylor | S | | Atlanta | GA | | 7702590658 |
| E | Listing | Taylor | S | | Atlanta | GA | | 4045681627 |
| E | Listing | Taylor | S T | | Atlanta | GA | | 4045342846 |
| E | Listing | Taylor | Sabrina | | Atlanta | GA | | 4045924765 |

*Information provided in this and the following tables has been changed from the actual data due to privacy concerns.

In this example, while the known method presents eight possible phone numbers, the rank code of E for these records indicate low confidence in the precision of the results. By pooling the data first, then applying a rank code, the volume of records returned may prevent the correct listing from being captured because of the common place nature of the searched name and locality. However, it is impractical to simply narrow the original primary search criteria include the full First Name or the Street and apply the known method, because many subscribers choose to list only their first initial, or choose to omit their address, and those potentially accurate listings would be missed entirely. DNC (do not call) indicators may be indicated by a “yes/no” flag based on subscriber requests, and need not be part of the search methodology.

Additionally, many records that do not match the input record exactly, due to data entry inconsistencies, for example, may not return any matches at all. For example, a directory assistance search for Fred Vargas at 16435 Stafford Road in Chagrin Falls, OH 44023 was found not to return any records using the known method because the locality was defined too narrowly; however, Fred Vargas is listed in the database at that street address in Auburn Township, an approved locality name for the same zip code.

To summarize, known searching methods for updating contact information often return inaccurate data due to ambiguity in the initial match criteria and the failure to anticipate potential data entry inconsistencies. Additionally, known ranking methods typically utilize a single set of criteria on which the rank codes are based, with the criteria set containing one fewer requirement for each lower rank code.

In contrast, the claimed method for processing data and ranking search results applies predetermined combinations of search criteria and match logic in an iterative manner to return, in the most preferred method, the single most accurate available match. Although manually reviewing up to ten records to locate the best one may not seem excessive, the typical number of records processed for a customer may be in the millions, requiring the customer to devote significant resources to manually review up to ten million records, for example.

Ranking may be defined in a similar manner to that utilized by known searching methods. However, the searching method of the present invention may begin with relatively narrow search criteria that is only then broadened if a matching record is not found. Using this new method with the same or similar rank codes as the known method, the aggregated data may first be searched using the A-rank criteria in the data set, and if no match is found, it may then be searched using the B-rank criteria, then the C-rank criteria, and so on. In this way, the single best record can be returned to the customer, without ambiguities flowing from use of the known searching methods.

FIG. 2 provides a simple overview of search methodology which may be employed in one preferred embodiment of the present invention. Using this embodiment, applied to the example of TABLE 2, returns the single match of a phone number for the Sarah Taylor record, avoiding the ambiguity of the known searching method, as shown above. Because the search method of the present invention initiates a more narrow search first, it returns the desired listing, eliminating the impact of ‘omit address’ listings, as below:

TABLE 3
Search Results For Method Of Present Invention, Using Query From Table 2

| RANK | | LAST | FIRST | | | | | |
|---|---|---|---|---|---|---|---|---|
| CODE | TYPE | NAME | NAME | STREET | LOCALITY | STATE | ZIP | PHONE |
| | Query | TAYLOR | SARAH | PEACHTREE DR | ATLANTA | GA | | |
| A | Listing | Taylor | Sarah | 4957 Peachtree Dr NE | Atlanta | GA | 30305 | 4042863947 |

Thus, the searching methodology of the present invention can improve the match process by providing the single best record.

In a second embodiment of the present invention, the set of match criteria assigned to each rank code may be expanded so that it is provided in a plurality of formats. This added granularity to the rank codes may further improve search results by allowing for discrepancies in input data. For instance, in the Fred Vargas example above, an A-ranked match would have been returned if Locality had been defined as “City, State” OR “ZIP code.” TABLE 4, below, illustrates an example of a refinement of the criteria sets that may be used with this embodiment.

TABLE 4
Example of expanded criteria sets for rank codes

| | | | # Records |
|---|---|---|---|
| Code | Pass | Ranking Criteria | Limiter |
| A | A1 | Last Name, First Initial, House #, Street, Zip | None |
| A | A2 | Last Name, First Initial, House #, Street, City, | None |
| | | State | |
| A | A3 | Last Name, First Initial, House #, Street, SCF¹ | None |
| B | B1 | Last Name, House #, Street, Zip | None |
| B | B2 | Last Name, House #, Street, City, State | None |
| B | B3 | Last Name, House #, Street, SCF | None |
| C | C1 | Last Name, First Name, Street, Zip | None |
| C | C2 | Last Name, First Name, Street, City, State | None |
| C | C3 | Last Name, First Initial, Street, Zip | None |
| C | C4 | Last Name, First Initial, Street, City, State | None |
| C | C5 | Last Name, First Name, Street, SCF | 2 |
| D | D1 | Last Name, Street, Zip | None |
| D | D2 | Last Name, Street, City, State | None |
| D | D3 | Last Name, Street, SCF | 2 |
| E | E1 | Last Name, First Name, Zip | 2 |
| E | E2 | Last Name, First Name, City, State | 2 |
| E | E3 | Last Name, First Initial, Zip | 2 |
| E | E4 | Last Name, First Initial, City, State | 2 |
| E | E5 | Last Name, First Name, SCF | 2 |
| F | F1 | Last Name, Zip | 2 |
| F | F2 | Last Name, City, State | 2 |

¹“SCF” stands for “Sectional Center Facility” and corresponds to the first three numbers in a zip code.

It can been seen from TABLE 4 that with an incremental broadening of the criteria, it may become desirable to limit the number of returned matches within a given rank code to prevent the return of an ambiguous match (as appeared with the known method in the “Sarah Taylor” example of TABLE 2). Examples of these “limiters” are represented in the right-hand column of TABLE 4.

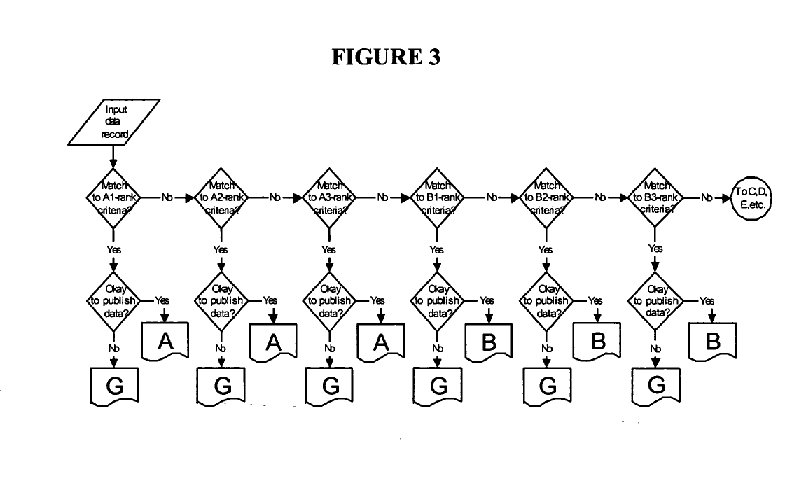

An overview of a sample searching methodology constituting the second embodiment of the present invention, the criteria sets for which are illustrated in TABLE 4, is represented in FIG. 3. The search methodology shown in FIG. 3 has been shown to provide significant improvements in total matches, most specifically in the higher-ranked (and therefore more accurate) match rates. TABLE 5, below, compares match rates yielded by known searching methods (“Known Method”) with those yielded by methods according to the present invention (“Claimed Method”).

TABLE 5
Comparison of known method and claimed method match rates

| | | Known | Claimed | Change |
|---|---|---|---|---|
| | | Method | Method | in |
| | | Match | Match | Match |
| Code | Minimum Match Criteria | Rate* | Rate* | Rate* |
| A | Last Name, First Initial, | 15.3 | 24.1 | 57% |
| | House #, Street, Locality | | | |
| B | Last Name, House #, | 18.4 | 12.2 | −34% |
| | Street, Locality | | | |
| C | Last Name, First Initial, | 0.7 | 1.4 | 95% |
| | Street, Locality | | | |
| D | Last Name, Street, Locality | 2.4 | 3.2 | 35% |
| E | Last Name, First Initial, | 11.1 | 12.3 | 11% |
| | Locality | | | |
| F | Last Name, Locality | 5.1 | 5.7 | 12% |
| G | Any listings above with a | 17.2 | 16.6 | −4% |
| | non-published number | | | |

*average percentage of matches based on review of in excess of 22 million records

While there was a significant increase in match rates in general using the claimed method, it can be seen that there is a substantial decline in B-ranked (and a slight decline in G-ranked) match rates. Logically, this reduction in B-ranked match rates may at least partially be attributed to the shift of known method B-ranked matches that, with the claimed method, can now be confirmed as A-ranked matches. However, even with this shift, the combined match rates of the top three rank codes evidence the marked improvement in match rates provided by the first and second embodiments of the present invention, as indicated in TABLE 6, below.

TABLE 6
Comparison of combined high-rank codes

| High-Rank | Known Method | Claimed Method | Change in |
|---|---|---|---|
| Code Groups | Match Rate* | Match Rate* | Match Rate* |
| A, B | 33.7 | 36.3 | 8% |
| A, B, C | 34.5 | 37.8 | 10% |

*average percentage of matches based on review of in excess of 22 million records

In a third embodiment of the present invention, the criteria sets for rank codes and searching methodology of TABLE 4 and FIG. 3 may be employed, but with added criteria sets to address data inconsistencies arising from misspelled last names and/or street names in either the query record or the searched database. An example of criteria that might be used to overcome such data inconsistencies is presented in TABLE 7, below.

TABLE 7
Example of additional criteria sets to overcome
data inconsistencies for rank codes

| | | | # Records |
|---|---|---|---|
| Code | Pass | Ranking Criteria | Limiter |
| A-F . . . | A1-F2 . . . | (refer to Table 3) | (refer to |
| | | | Table 3) |
| P | P1 | Last Name, First Initial, House #, | None |
| | | First Initial of Street, Zip | |
| P | P2 | Last Name, First Initial, House #, | None |
| | | First Initial of Street, City, State | |
| P | P3 | Last Name, First Initial, House #, | None |
| | | First Initial of Street, SCF | |
| S | S1 | First Initial of Last Name, First | None |
| | | Initial, House #, Street, Zip | |
| S | S2 | First Initial of Last Name, First | None |
| | | Initial, House #, Street, City, State | |
| S | S3 | First Initial of Last Name, First | None |
| | | Initial, House #, Street, SCF | |

These additional criteria sets have been shown to result in a greater number of potential matches by broadening the search to include matches where all other data match except the last name, but the initial of the last name matches (P code), or all other data match except the street name, but the initial of the street name matches (S code). It is recognized that these matches may not have the precision of earlier matches resulting from use of the first and second embodiments of the present invention, shown above; however, in most cases a potential match is preferred over no match at all.

Use of the criteria sets for rank codes and searching methodology illustrated in the three alternative embodiments of the present invention, disclosed above, has been found to increase the overall data match rate to as high as 80%, which is 15% to 45% higher than the match rates of 35% to 65% total matches promoted by many data search companies. The increase in the rate of A-ranked matches, which the claimed method improves by up to 57%, is potentially of even more significance.

While it is believed that those of ordinary skill in the art reading the foregoing will easily be enabled to practice the present invention, a few additional items of information are provided. It will be understood that data aggregating companies apply/overlay their own searching logic to searching methodology of the present invention, for example, to reduce the possibility that extraneous information (e.g., field parsing, street directionals, ordinals and avenue, boulevard, etc.) induces a false match or misses an otherwise optimal match. Thus, a data aggregating company's search logic may strip out such extraneous information prior to attempting a match.

An exemplary delivery file format showing fields that may be output to a customer, including exemplary starting and ending positions for character inputs for each field, is shown in Table 8, below.

TABLE 8
Exemplary delivery file format

| Field | | | |
|---|---|---|---|
| (italics = appended data) | #Chars | Start Pos | End Pos |
| Name | 30 | 1 | 30 |
| Address-1 | 30 | 31 | 60 |
| Address-2 | 30 | 61 | 90 |
| City | 20 | 91 | 110 |
| State | 2 | 111 | 112 |
| Zip | 5 | 113 | 117 |
| Zip + 4 | 4 | 118 | 121 |
| SSN (social security number) | 9 | 122 | 130 |
| Cust_Reference | 30 | 131 | 160 |
| MatchCode | 1 | 161 | 161 |
| PhoneNumber | 10 | 162 | 171 |
| TimeZone | 3 | 172 | 174 |
| DNC (do not call) | 1 | 175 | 175 |

The invention was initially developed to provide data matches relating to contact information, and to include a rank code to indicate the precision of the match. However, this same logic may be applied to any data mining operation in which data is compared to a set of criteria and matched accordingly. Thus, additional uses of the invention include but are not limited to the matching and precision ranking of: demographic data; customer historical activity data (purchases, maintenance issues, etc.); Internet surfing history; or other legally collected data.

Other changes and modifications constituting insubstantial differences from the present invention, such as those expressed here or others left unexpressed but apparent to those of ordinary skill in the art, may be made without departing from the spirit and scope of the present invention and without diminishing its attendant advantages. It is, therefore, intended that such changes and modifications be covered by the following claims.

We claim:

1. A method for updating contact information by optimizing the match of known customer data to data within aggregated contact databases, comprising the steps of:
receiving the known customer data, the known customer data comprising identity data including one or more identity categories corresponding to an entity;
determining whether the identity data is a data set constituting an optimized match to a first order data set generated using a first order of predetermined ranking criteria;
if a match does not exist, determining whether the identity data is an optimized match to a second order data set generated using a second order of predetermined ranking criteria; and
if a match does not exist, determining whether the identity data is an optimized match to sequential order data sets generating using corresponding sequential orders of predetermined ranking criteria, until an optimized match is found to exist.

2. The method of claim 1, wherein a rank code based on the highest order of the data set generated using the highest order of predetermined ranking criteria that provided the optimized match is assigned to the optimized match.

3. The method of claim 1, further comprising the step of providing to a third party a desired portion of the data set of the optimized match.

4. The method of claim 3, wherein the desired portion of the data set of the optimized match comprises a telephone number for the entity.

5. The method of claim 3, wherein the desired portion of the data set of the optimized match comprises a street address for the entity.

6. The method of claim 3, further comprising the step of reassigning selected data comprising a subset of the data sets of the optimized matches prior to the step of providing to a third party only a desired portion of the data set of the optimized match.

7. The method of claim 6, wherein the data is selected in the reassigning step based on whether the selected data or a portion thereof is available as having been published.

8. The method of claim 4, wherein the desired portion of the data set of the optimized match comprises information indicating with a higher degree of precision whether or not a telephone number is the most current number associated with the known customer data corresponding to an entity.

9. The method of claim 1, wherein the aggregated contact databases are selected from one or both of the following group consisting of: aged information relating to the individuals or entities; and current information relating to the entities.

10. The method of claim 1, wherein the identity categories are selected from one or more of the following group consisting of: last name; first initial; house number; street; city; state; and zip code or portion thereof.

11. The method of claim 1, wherein the first order of predetermined ranking criteria is more specific than the second order of predetermined ranking criteria.

12. The method of claim 1, wherein the first order of ranking criteria comprises, for an entity, at least four or more of the following: last name, first initial, first name, house or building number, street, city, state, and zip code or portion thereof.

13. The method of claim 12, wherein the second order of ranking criteria comprises, for an entity, three or more of the criteria comprising the first order of ranking criteria, but one less criterion in total number than the first order of ranking criteria.

14. The method of claim 1, wherein six orders of ranking criteria (e.g., A-F rank codes) are employed.

15. The method of claim 14, wherein at least one of the orders of ranking criteria (e.g., the A-rank) comprises differing sets of match criteria within the same order (e.g., A1-rank, and A2-rank), and further comprising the step of attempting multiple match determinations within at least one order of the ranking criteria.

16. The method of claim 1, wherein a determination that an optimized match exists is made when all criteria within a particular order of ranking criteria are matched except the last name, and the initial or other portion of the last name constitutes a match.

17. The method of claim 1, wherein a determination that an optimized match exists is made when all criteria within a particular order of ranking criteria are matched except the street name, and the initial or other portion of the street name constitutes a match.

18. The method of claim 1, wherein the match determination process is initialized using the order of ranking criteria that corresponds to the number of identity categories that are present within the known customer data.

19. The method of claim 1, wherein the optimized match comprises a data set deemed to constitute the single best match for the corresponding known customer data.

20. The method of claim 1, wherein the optimized match comprises two or more data sets deemed to constitute the best matches for the corresponding known customer data.

21. The method of claim 19 wherein, in addition to the optimized match, other data sets are stored which have significant correspondence with the known customer data.

22. A method for updating demographic information by optimizing the match of known customer data to data within aggregated demographic databases comprising the steps of:
receiving the known customer data, the known customer data comprising demographic data including one or more demographic categories corresponding to an entity;
determining whether the demographic data is a data set constituting an optimized match to a first order data set generated using a first order of predetermined ranking criteria;
if a match does not exist, determining whether the demographic data is an optimized match to a second order data set generated using a second order of predetermined ranking criteria; and
if a match does not exist, determining whether the demographic data is an optimized match to sequential order data sets (i.e., third order, fourth order, etc.) generating using corresponding sequential orders of predetermined ranking criteria, until an optimized match is found to exist.

23. A method for updating transactional information by optimizing the match of known customer data to transactional data within aggregated databases, comprising the steps of:
receiving the known customer data, the known customer data comprising transactional data including one or more transactional categories corresponding to an entity;
determining whether the transactional data is a data set constituting an optimized match to a first order data set generated using a first order of predetermined ranking criteria;
if a match does not exist, determining whether the transactional data is an optimized match to a second order data set generated using a second order of predetermined ranking criteria; and
if a match does not exist, determining whether the transactional data is an optimized match to sequential order data sets (i.e., third order, fourth order, etc.) generating using corresponding sequential orders of predetermined ranking criteria, until an optimized match is found to exist.
